(19) United States
(12) Patent Application Publication
(10) Pub. No.: US 2003/0185184 A1
(43) Pub. Date: Oct. 2, 2003

(54) Processor device for coupling to various facilities

(76) Inventor: Roger Wu, Hsin Chuang City (TW)

Correspondence Address: Roger Wu, P.O. Box 4-67, Hsin Chuang, Taipei, 242, TW

(21) Appl. No.: 10/116,779

(22) Filed: Apr. 2, 2002

(51) Int. Cl. H04Q 7/24

(52) U.S. Cl. 370/338

(57) ABSTRACT

A processor assembly includes a processor device including a CPU and one or more memories coupled to the CPU, an LAN, a WLAN, an audio and/or video input device, an audio and/or video output device, and a peripheral component interconnect coupling the LAN, the WLAN, and the audio and/or video input device, and the audio and/or video output device to the processor device, for allowing the LAN, the WLAN, and the audio and/or video input device, and the audio and/or video output device to be coupled together and to be processed by the processor device.

### BACKGROUND OF THE INVENTION

1. Field of the Invention

The present invention relates to a processor assembly, and more particularly to a processor assembly for coupling to various facilities.

2. Description of the Prior Art

Typical processor devices may include one or more sockets provided therein for plugging or coupling to various kinds of programs or systems or facilities, such as the wireless local area network (WLAN), the local area network (LAN), the video recorders, the cameras, the compact disc players, etc., which are coupled to the processor device individually or separately, and which may not be coupled together.

The present invention has arisen to mitigate and/or obviate the afore-described disadvantages of the conventional processor devices.

### SUMMARY OF THE INVENTION

The primary objective of the present invention is to provide a processor assembly including an interconnect for coupling to various programs or systems or facilities and for allowing the programs or systems or facilities to be coupled together or worked together.

In accordance with one aspect of the invention, there is provided a processor assembly comprising a processor device including a central processing unit and at least one memory coupled to the central processing unit, a local area network, a wireless local area network, an audio and/or video input device, an audio and/or video output device, and means for coupling the local area network, and the wireless local area network, and the audio and/or video input device, and the audio and/or video output device to the processor device. The local area network, and the wireless local area network, and the audio and/or video input device, and the audio and/or video output device may thus be coupled together and may thus be worked or processed or treated together with the processor device. The audio and/or video signals from the audio and/or video input device, may be sent into the processor device via the moving pictures expert group and then may be treated or processed by the processor device, and then may be sent out or displayed or output by the audio and/or video output device.

The coupling means includes a peripheral component interconnect coupled to the local area network, and the wireless local area network, and the audio and/or video input device, and the audio and/or video output device to the processor device.

A moving pictures expert group and a video signal processor may further be provided and coupled between the audio and/or video input device and the peripheral component interconnect.

A television module may further be provided and coupled to the video signal processor for outputting or displaying the audio and/or the video signals. A digital/analog converter may further be provided and coupled between the audio and/or video output device and the moving pictures expert group for converting the digital signals into the analog signals that may then be output or displayed in the audio and/or video output device.

The coupling means includes a coupler coupled to the peripheral component interconnect, for coupling to the wireless local area network.

The memory of the processor device includes a synchronous dynamic memory, and/or includes a flash memory for storing the information or data of the central processor unit.

A wide area network may further be provided and coupled to the coupling means.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram illustrating an interconnect of a processor assembly in accordance with the present invention for coupling the processor assembly to various kinds of programs or systems or facilities.

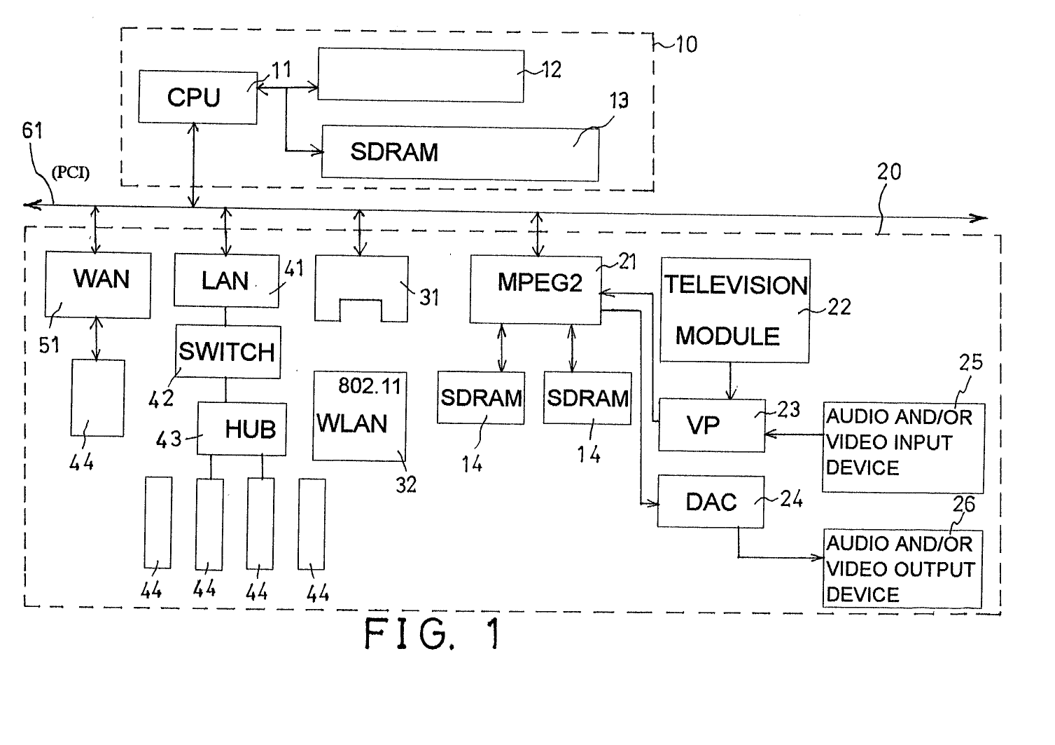

### DETAILED DESCRIPTION OF THE PREFERRED EMBODIMENT

Referring to the drawing, a processor assembly in accordance with the present invention comprises a processor device 10 including a central processing unit (CPU) 11, and one or more memories, such as the flash memories 12 and/or the synchronous dynamic random access memories (SDRAM) 13 coupled to the CPU 11; and a peripheral component interface or interconnect (PCI) 61 coupled to the CPU 11, for coupling the CPU 11 to various kinds of programs or systems or facilities.

For example, a moving pictures expert group (MPEG) device or program, such as a MPEG2 or MPEG device 21, a plug or a coupler 31 for coupling to a WLAN device 32, an LAN device 41, and/or a wide area network (WAN) device 51 may be selectively provided and coupled to the PCI 61, for selectively coupling to the CPU 11. One or more memories, such as the flash memories and/or SDRAM 14 may further be provided and coupled to the MPEG device 21.

A video frequency or signal processor (VP) 23 may be provided and coupled to the MPEG device 21. A television module 22 and/or the other audio and/or video input devices 25, such as the radio facilities, the microphones, the compact disc players, the laser disc players, the video recorders, the cameras, etc., may further be provided and coupled to processor device 10 via the MPEG device 21 and the VP 23, for transmitting the audio or the video signals to the MPEG device 21, and for allowing the audio signals and/or the video signals to be treated or processed by the MPEG device 21 and then to be sent to the processor device 10.

The MPEG device 21 may be coupled to one or more audio and/or video output devices 26, such as the radio facilities, the speakers, the televisions, the computers or the monitors, the video cameras, video phones, web cameras, etc., via a digital/analog converter (DAC) 24, for outputting the audio and/or video signals.

The LAN device 41 and/or the wide area network (WAN) device 51 may each include one or more plugs or sockets or couplers 44 for selectively coupling to various kinds of programs or systems or facilities, such as the broadband routers, the web browsers, the video on demand clients, the wireless access points, the video recorders, the video phones, the web cameras, etc. The plugs 44 may be coupled to the LAN device 41 via a switch device 42 and/or a hub 43 that may be used for coupling a number of wires or cables together.

It is to be noted that the various kinds of programs or systems or facilities, such as the LAN device 41, and/or the wide area network (WAN) device 51, and/or the WLAN 32, and/or the audio and/or video input or output devices 25, 26 may be coupled to the processor device 10 via the PCI 61, and may be coupled together with the PCI 61, and may be worked together or processed and/or treated by the processor device 10.

Accordingly, the processor assembly in accordance with the present invention includes an interconnect for coupling to various programs or systems or facilities and for allowing the programs or systems or facilities to be coupled together or worked together.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A processor assembly comprising:
a processor device including a central processing unit and at least one memory coupled to said central processing unit,
a local area network,
a wireless local area network,
an audio and/or video input device,
an audio and/or video output device, and
means for coupling said local area network, and said wireless local area network, and said audio and/or video input device, and said audio and/or video output device to said processor device.

2. The processor assembly according to claim 1, wherein said coupling means includes a peripheral component interconnect coupled to said local area network, and said wireless local area network, and said audio and/or video input device, and said audio and/or video output device to said processor device.

3. The processor assembly according to claim 2, wherein said coupling means includes a coupler coupled to said peripheral component interconnect, for coupling to said wireless local area network.

4. The processor assembly according to claim 1, wherein said at least one memory of said processor device includes a synchronous dynamic memory.

5. The processor assembly according to claim 1, wherein said at least one memory of said processor device includes a flash memory.

6. The processor assembly according to claim 1 further comprising a wide area network coupled to said coupling means.

7. The processor assembly according to claim 1, wherein said coupling means includes a peripheral component interconnect and a moving pictures expert group and a video signal processor coupled between said audio and/or video input device and said processor device.

8. The processor assembly according to claim 7 further comprising a television module coupled to said video signal processor.

9. The processor assembly according to claim 1, wherein said coupling means includes a peripheral component interconnect and a moving pictures expert group and a digital/analog converter coupled between said audio and/or video output device and said processor device.
